(19) United States
(12) Patent Application Publication
(10) Pub. No.: US 2025/0110485 A1
(43) Pub. Date: Apr. 3, 2025

(54) AUTONOMOUS AI QUALITY INSPECTION SYSTEM FOR MANUFACTURED OBJECTS

(71) Applicant: Techolution Consulting LLC, New York, NY (US)

(72) Inventor: Luv Tulsidas, New York, NY (US)

(73) Assignee: Techolution Consulting LLC, New York, NY (US)

(21) Appl. No.: 18/376,402

(22) Filed: Oct. 3, 2023

(51) Int. Cl. G05B 19/418; G06T 7/00

(52) U.S. Cl. CPC G05B 19/41875; G06T 7/0004; G05B 2219/33002

(57) ABSTRACT

The present application relates to an autonomous AI quality inspection system that uses robotics, AI and computer vision technology to measure and inspect various parameters of manufactured objects, including but not limited to fasteners such as nuts, bolts, screws, and nails. The autonomous system uses computer vision to capture raw images of the objects, inspect their key parameters, and display the quality assurance (QA) results on an interactive application dashboard and achieve a consistent precision level of up to 0.01 mm. The system comprises of an edge gateway connected to a high-resolution camera that captures images of the objects and a cloud server that detects the images, removes background of the objects, fetches the edges and points, calculates the key characteristics and thereby displays the computed data on a user dashboard for quality control check. The system can be adapted to different types of manufacturing objects by a one-time onboarding process.

### TECHNICAL FIELD OF THE INVENTION

This application relates to the field of quality control in the manufacturing industry, specifically the present application relates to an AI powered autonomous system providing a unique solution to measure and inspect various parameters of manufactured objects and achieve a consistent precision level and perform quality control checks for multiple manufactured objects at the same time.

### BACKGROUND OF THE INVENTION

Manufacturing objects, including fasteners, are essential components in many industries, including automotive, aerospace, construction, and manufacturing. They are used to connect two or more objects together and are critical to the overall quality and safety of the products in which they are used. Ensuring the quality of such objects is therefore of utmost importance to prevent failures and accidents.

The quality control of manufacturing objects, including fasteners, is crucial for ensuring that products are safe and reliable. Defective products can lead to serious accidents, product recalls, and damage to a company's reputation. However, traditional quality control methods, such as manual inspection, are often slow, labor-intensive, and prone to errors. Automated inspection systems have been developed in recent years, but they often lack the accuracy and reliability required for high-speed production lines.

In the manufacturing industry, quality inspection is a critical step in ensuring that products meet the desired specifications and are free from defects. The users manually measure and inspect various parameters of the manufacturing objects using measuring devices, for instance vernier calipers and other tools. The quality inspection takes a long time and also involves manual documentation of results which is extremely slow, leading to large backlogs. These processes can be time-consuming, labor-intensive, and subjective, with the potential for human error.

To address these challenges, various automated inspection systems have been developed, such as computer vision systems and robotic inspection systems. These systems use cameras and sensors to inspect objects and identify defects. However, these systems are often limited in their accuracy and effectiveness, and may require significant manual programming and calibration to achieve optimal performance.

The conventional quality inspection systems suffer from several challenges. Firstly, a significant amount of labor is required to measure the dimensions of objects and perform quality control checks. This process is slow, time-consuming, and has low throughput. Secondly, the conventional process is tedious and manual, which results in errors and inconsistencies. Thirdly, the manual documentation of results is prone to errors, which can lead to inaccurate conclusions. Lastly, training employees on the quality assurance process is a time-consuming and labor-intensive process. These challenges result in reduced efficiency, increased labor costs, and a higher risk of errors in the quality inspection process.

The present invention seeks to address the limitations of traditional quality inspection methods and automated inspection systems by providing an autonomous AI quality inspection system for manufactured objects. The system is designed to provide consistent and precise measurements of various parameters of manufactured objects in real-time, with the least human interaction. The system can be adapted to different types of manufactured objects by a one-time onboarding process, making it highly versatile.

### SUMMARY OF THE INVENTION

The present invention is directed towards an autonomous artificial intelligence (AI) system to measure and inspect various parameters of manufactured objects, including but not limited to fasteners such as nuts, bolts, screws, and nails. The system can operate in real-time, allowing for quality control checks for multiple manufacturing objects at the same time.

The AI quality inspection system for manufacturing objects has the potential to significantly improve the efficiency and accuracy of quality inspection. By using computer vision and machine learning algorithms, the system can quickly and accurately detect defects. The development of an effective AI quality inspection system for manufacturing objects would require a multidisciplinary approach, involving experts in computer vision, machine learning, and fastener manufacturing. However, the potential benefits of such a system make it an attractive option for fastener manufacturers looking to improve their quality control processes.

In an embodiment of the present invention, the system for autonomous AI quality inspection of manufactured objects, comprises of an edge gateway connected to a high-resolution camera for capturing images of the objects; a cloud server comprising a computer vision algorithm for detecting and processing the images, and calculating key characteristics of the objects, including but not limited to length, thread diameter, neck diameter, and head profile diameter; a user dashboard for displaying the calculated data and enabling quality control checks to be performed in real-time; and an automated QC report generator for producing reports that meet regulatory requirements

In an another embodiment of the present invention, the system further comprises of a processing unit for analyzing and processing the images and transferring it to a cloud server; a cloud server that detects the images removes the background of the objects, fetches the edges and points, calculates the key characteristics and displays the computed data on a user dashboard (output device) for quality control check.

It should be noted that while the present invention has been described with reference to fasteners, it is not limited to this particular type of manufactured object and can be adapted to inspect other types of objects as well. Additionally, various modifications and alterations to the system and method may be possible without departing from the scope of the invention.

### BRIEF DESCRIPTION OF THE DRAWINGS

The foregoing summary, as well as the following detailed description of various embodiments, is better understood when read in conjunction with the drawings provided herein. For the purposes of illustration, the drawings disclose subject matter which is not limited to the specific methods and instrumentalities disclosed. Further, the advantages and features of the present disclosure will better understood with reference to the following detailed description and claims taken in conjunction with the accompanying drawing, wherein like elements are identified with like symbols, and in which:

FIG. 1 illustrates the system diagram of the autonomous AI quality inspection system.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

Further, the use of terms “first”, “second”, and “third”, and the like, herein do not denote any order, quantity, or importance, but rather are used to distinguish one element from another.

The proposed system is resolving the challenges faced by several industries including but not limited to medical and manufacturing industries.

The conventional method for measuring items such as screws involves the use of screw gauges and vernier calipers, which provide a range of precision levels. The most commonly used device offers a precision of 0.01 mm. However, achieving this level of precision using traditional methods often involves challenges related to human error and the time required for each measurement.

The present application provides an autonomous artificial intelligence system 105 to measure and inspect various parameters of manufactured objects 103, including but not limited to fasteners such as nuts, bolts, screws, and nails.

The primary advantage of this system is that it is an autonomous system with essentially no error(s) and is able to achieve a consistent precision level of up to 0.01 mm (10 microns) and rapid quality inspection autonomously through computer vision. The present system is able to perform quality control checks for multiple manufacturing objects at the same time.

The autonomous vision based measurement system, autonomously captures raw images of the manufacturing objects, inspects the key parameters (object length, thread diameter, neck diameter, neck diameter, head profile diameter & others) of such objects and displays the QA result with the data on an interactive application dashboard for quality control check to attain accuracy and high precision level, ensuring a fast and reliable quality check that includes automated documentation according to regulatory requirements. The system can be dynamically adapted for different types of manufacturing objects by a one time on-boarding process where the user can input the required product details into the QC system.

To operate effectively, the system relies on a high-resolution camera (64 megapixels or better) and a reference picture of a correctly manufactured version of the product. This reference image is used for product onboarding. With this information, the system can detect and highlight defects in products with an impressive precision of 0.01 mm. The high-resolution image alone does not possess the capability to assess object quality or achieve such a high level of precision; it's the AI system developed that provides this capability.

The technology developed does not require specific training for individual products or product sizes. It can detect the height, width, and defects in objects as long as certain conditions regarding camera quality, lighting, and other factors are met.

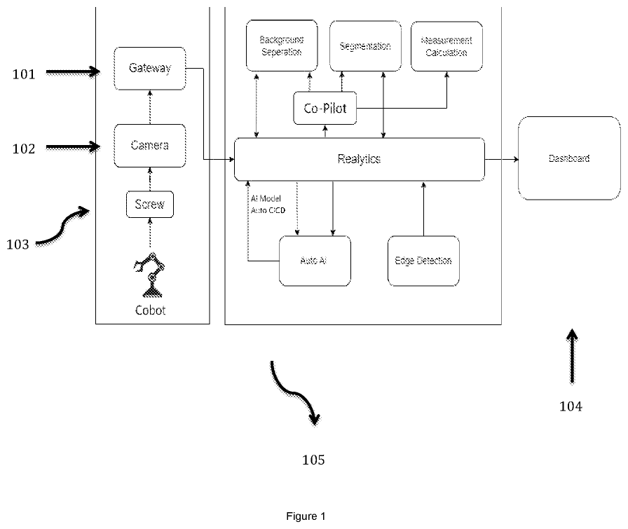

The system 105 comprises of an edge gateway 101 equipped with a high-resolution camera 102 that captures raw images of the objects 103; a processing unit for analyzing and processing the images and transferring it to a cloud server; the cloud server calculates key characteristics of the objects 103, including but not limited to length, thread diameter, neck diameter, threads per inch (tpi), and head profile diameter, or any other fastener characteristic; a user dashboard 104 that displays the calculated data and enabling quality control checks to be performed in real-time; and an automated QC report generator for producing reports that meet regulatory requirements as illustrated in FIG. 1.

The computed data is displayed on an interactive application dashboard 104, which provides a comprehensive view of the quality assurance (QA) results. The dashboard 104 displays the measured parameters, and other relevant information, such as the date and time of the inspection, and the location of the object 103.

The system is preferably designed to achieve a consistent precision level of up to 0.01 mm without human intervention, providing highly accurate measurements of the objects in comparison to the manual instruments like vernier caliper and screw gauges. The system captures the images of the objects using a high resolution camera, background of the objects is removed via using a machine learning algorithm to obtain accurate edges and points of objects up to a precision level 0.01 mm.

The present invention aims to achieve the same 0.01 mm precision by eliminating the human element from the process. This not only reduces the likelihood of discrepancies due to human factors but also minimizes the time needed for measurements.

To validate the effectiveness of this approach, several tests were conducted by measuring various screws of different sizes and shapes. Thereafter the measurements obtained were compared using manual methods with those obtained through our device or application.

Furthermore, the present computer vision-based measurement system has been meticulously designed, calibrated, and validated to ensure it provides dimensional measurements of medical screws with an accuracy of 0.01 mm. Regular benchmarking against physical measurements and the implementation of advanced image acquisition and processing techniques provides assurance of the system's precision and reliability.

The system can be adapted to different types of manufactured objects by a one-time onboarding process, which includes training the deep learning algorithms on a dataset of the specific object type.

The autonomous nature of the system reduces the potential for human error and subjectivity, improving the accuracy and consistency of the inspection process. The system can be integrated into the manufacturing process, providing a comprehensive quality control solution for manufactured objects.

The objects include but are not limited to fasteners such as nuts, bolts, screws, and nails.

The system is adaptable for different types of manufacturing objects through a one-time onboarding process wherein the user inputs the required product details into the QC system.

Furthermore, the system can perform quality control checks for multiple manufacturing objects simultaneously.

The system also consists of a database for storing manufacturing object details and for dynamically adapting the system to different types of manufacturing objects by a one-time onboarding process.

The cloud platform here may be referred to as a cloud or a physical server located in a remote location. The cloud platform comprises a plurality of computing devices that are distributed over a plurality of geographical areas. The cloud platform is configured to function as a server and database that stores user information, etc.

The system includes a computer program product for autonomous AI quality inspection of manufactured objects, comprising: computer-readable instructions for capturing raw images of the objects using a high-resolution camera; computer-readable instructions for processing the images in real-time using a computer vision algorithm to detect and calculate key characteristics of the objects, including but not limited to length, thread diameter, neck diameter, and head profile diameter; computer-readable instructions for displaying the calculated data on an interactive application dashboard for quality control checks to be performed in real-time; and computer-readable instructions for generating an automated QC report.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

1. A system for autonomous AI quality inspection of manufactured objects, comprising:
a) an edge gateway connected to a high-resolution camera for capturing images of the objects;
b) a cloud server comprising a computer vision algorithm for detecting and processing the images, and calculating key characteristics of the objects, including but not limited to length, thread diameter, neck diameter, and head profile diameter;
c) a user dashboard for displaying the calculated data and enabling quality control checks to be performed in real-time; and
d) an automated QC report generator for producing reports that meet regulatory requirements.

2. The system of claim 1, wherein the AI algorithm leverages computer vision technology for real-time object detection and measurement with an accuracy and precision level of up to 0.01 mm.

3. The system of claim 1, wherein the objects include but are not limited to fasteners such as nuts, bolts, screws, and nails.

4. The system of claim 1, wherein the system is dynamically adaptable for different types of manufacturing objects through a one-time onboarding process wherein the user inputs the required product details into the QC system.

5. The system of claim 1, wherein the system performs quality control checks for multiple manufacturing objects simultaneously.

6. The system of claim 1, further comprising a database for storing manufacturing object details and for dynamically adapting the system to different types of manufacturing objects by a one-time onboarding process.

7. The system of claim 1, wherein the cloud server is further configured to remove the background of the objects, fetch edges and points of the objects, and detect color characteristics of the objects.

8. A computer program product for autonomous AI quality inspection of manufactured objects, comprising:
a) computer-readable instructions for capturing raw images of the objects using a high-resolution camera;
b) computer-readable instructions for processing the images in real-time using a computer vision algorithm to detect and calculate key characteristics of the objects, including but not limited to length, thread diameter, neck diameter, and head profile diameter;
c) computer-readable instructions for displaying the calculated data on an interactive application dashboard for quality control checks to be performed in real-time; and
d) computer-readable instructions for generating an automated QC report that meets regulatory requirements.

9. The computer program product of claim 8, wherein the computer vision algorithm is capable of identifying and removing background from the object images.

10. The computer program product of claim 8, wherein the computer vision algorithm is capable of dynamically adapting to different types of manufactured objects by on-boarding product details into the QC system.

11. The computer program product of claim 8, wherein the computer vision algorithm is capable of performing quality control checks for multiple manufacturing objects at the same time.
